(19) United States
(12) Patent Application Publication
(10) Pub. No.: US 2016/0088976 A1
(43) Pub. Date: Mar. 31, 2016

(54) METHOD OF HEATING FOOD IN AN ACCELERATED COOKING OVEN

(71) Applicant: West Carrollton Parchment & Converting, Inc.

(72) Inventor: Cameron Lonergan, West Carrollton City, OH (US)

(21) Appl. No.: 14/560,187

(22) Filed: Dec. 4, 2014

Related U.S. Application Data
(60) Provisional application No. 62/056,763, filed on Sep. 29, 2014.

(51) Int. Cl. A47J 43/20; A23L 1/01

(52) U.S. Cl. CPC A47J 43/20; A23L 1/0128; A23V 2002/00

(57) ABSTRACT

Food can be cooked in an accelerated cooking oven by placing the food on a heat-resistant liner and, in particular, a liner formed from vegetable parchment filled with an inert inorganic filler such as titanium dioxide. The parchment paper is coated on one or both sides with a silicone release coating. In one embodiment of the present invention, the parchment paper can be creped from about 5 to about 12%. This liner is suitable for use in an accelerated cooking oven to prevent messes from forming in the oven without significant discoloration, burning or flaking.

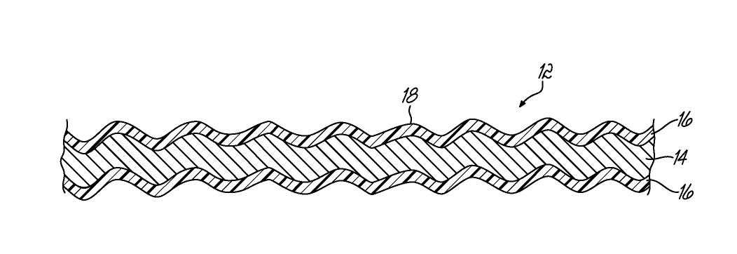

### PRIORITY CLAIM

Benefit of the filing date of Sep. 29, 2014 of provisional patent application Ser. No. 62/056,763 entitled “METHOD OF HEATING FOOD IN AN ACCELERATED HEAT OVEN” is claimed, and that application, in its entirety, is expressly incorporated herein as if fully set out herein.

### BACKGROUND OF THE INVENTION

Accelerated cooking ovens use a combination of impinged air and microwaves to very quickly cook or heat food items. These ovens are particularly useful for cooking or heating individual, smaller food items such as sandwiches, particularly in, for example, a sandwich shop or the like. Generally, these ovens heat items from room temperature to the desired eating temperature in one minute or less.

Any time one cooks something in an oven, splattering can occur and other messes can be created which require constant cleaning of the oven. To avoid this, small food items can be placed on a liner so as to prevent a mess from forming on the internal surface of the oven. Due to the high temperatures of these accelerated cooking ovens, normal liner material cannot be used. Thermoplastic liners would typically melt. Foil cannot be used because of the microwave portion of the oven. Typical paper products tend to char and fragment.

Thicker reusable materials, such as silicone rubber, glass or ceramic, could be employed, but these may slow down or impede the cooking and, further, they would require cleaning.

### SUMMARY OF THE INVENTION

The present invention is premised on the realization that food items can be cooked in an accelerated cooking oven by placing the food item on a parchment material, in particular, a vegetable parchment filled with an inert inorganic filler which enables the parchment to resist the conditions of an accelerated cooking oven.

More particularly, the present invention provides a method of cooking food wherein the food rests in the oven on a sheet which comprises vegetable parchment having an inorganic filler in an amount effective to provide adequate heat resistance for the vegetable parchment in the accelerated cooking oven.

The vegetable parchment can include a nonstick coating on one or both surfaces. Using a creped vegetable parchment sheet further facilitates cooking of the food items.

Further, the invention includes a vegetable parchment filled with an effective amount of an inorganic filler, such as titanium dioxide, and having at least one surface coated with a silicone nonstick surface.

The objects and advantages of the present invention will be further appreciated in light of the following detailed description and drawing in which:

### BRIEF DESCRIPTION OF THE DRAWINGS

The FIGURE is a cross-sectional view broken away of the liner sheet used in the present invention.

### DETAILED DESCRIPTION

According to the present invention, a cooking sheet 12, also referred to as a liner, which can be used in an accelerated cooking oven, includes a parchment layer 14, shown as a creped parchment layer, which includes one or both surfaces coated with a silicone release coating. As shown, the parchment layer includes two silicone release coating layers 16 on either planar surface.

For use in the present invention, the parchment is a vegetable parchment which is a paper formed by subjecting cellulosic fibers to sulfuric acid, which forms an amyloid film on the exterior of the fibers. When the acid is washed off, the amyloid film hardens on the fibers and in the interstices of the paper. This increases the strength of the paper and enables it to be contacted with water without disintegration. Basically any vegetable parchment can be used in the present invention. These are formed with various types of cellulosic fibers, such as hardwood fibers and softwood fibers, as well as cotton fibers and the like.

The weight of the parchment can vary widely. Generally, the parchment will have a weight of about 20 to 40 pounds per 3000 square feet, more typically 25 to 35 pounds, generally 27 pounds per 3,000 square foot ream (prior to creping). The thickness of the parchment prior to creping can also vary widely, generally from about 0.002″ to about 0.003″ prior to creping. If creped, the thickness of the paper will increase to 0.009″ to 0.013″. Vegetable parchment is available from a variety of different sources.

The parchment of the present invention will further include an amount of a non-toxic inert, inorganic filler which can withstand the sulfuric acid reaction conditions in an amount effective to prevent the parchment from charring and, in particular, for 2 minutes at 500° F. as described in the example below. Suitable fillers include metal oxides such as titanium oxide, zinc oxide, as well as others, as long as they can withstand the sulfuric acid treatment conditions.

The amount of filler added will assist in providing the high temperature resistance required in the present invention. Generally, this can be from 10 to 40 kg per metric tonne (1000 kg of fiber). Generally this will be 30 to 40 kg with a maximum loading of 40 kg, providing the maximum heat resistance.

The moisture content of the parchment is generally 5-7%, generally 5.5-6.5% and in particular 6.3% by weight.

The parchment paper can be smooth parchment paper or it can be creped if desired. Creping creates an undulating surface 18 which may improve heat flow and airflow around the item being cooked. Creping from 5 to 12%, and in particular about 9.5%, improves the browning of products using the sheet of the present invention.

Further, at least one side of the sheet 12 may be coated with a silicone release coating 16. As shown in the FIGURE, preferably both sides of sheet 12 include coating 16. The thickness of the silicone coating should range from 0.1 to 0.3 lbs/3000 ft² ream on a dry basis. In particular, coating a first side with 0.123 lbs/3000 ft² and the second side with 0.148 lbs/3000 ft² works well. Such silicone coatings are commercially available and any food grade silicone coating which will adhere to the parchment can be used in the present invention. Generally, if the parchment is creped, the coatings 16 are generally applied prior to the creping.

According to the present invention, a food item is cooked in an accelerated cooking oven by placing the food item on the sheet 12 in an accelerated cooking oven. Generally, these ovens operate with a combination of heated impinged air and microwaves. These ovens impinge a stream of hot gas at the center of the oven where the food item is positioned. These ovens operate at temperatures of 300° F. to 500° F., but generally operate at a very short period of time, such as 20 to 30 seconds. Alternately, the food item may be wrapped in the liner, if desired. No tape or other binding agent is required. Simply the folding of the paper around the food product will keep it in position.

The sheet 12 of the present invention was tested in an accelerated cooking oven. The sheet of vegetable parchment was 27 pounds per 3000 square-foot ream with 40 kg of titanium dioxide per metric tonne coated with a silicone release coating on both sides, creped 9.5% and had a moisture content of 0.3%. A TurboChef® oven was preheated to 500° F. A dry, unseeded, hard-crusted sandwich roll was wrapped in the sheet 12 which measured 11″×13″. The covered sandwich roll was placed in a silicone-covered mesh basket. No closures were used. The weight of the roll kept the parchment in place around the roll.

The door of the oven was opened and the silicone-covered mesh basket was placed in the oven directly on top of a cooking stone. The wrapped roll was cooked for two minutes at 500° F. impinged air only. At the completion of the cooking time, the oven door was opened, the silicone-covered mesh basket was removed and placed on a stainless steel work surface.

The sheet was carefully inspected. It remained closed around the roll, where there was only the slightest amount of discoloration and no apparent physical damage to the sheet. The package was then opened. The parchment wrapping experienced the slightest amount of discoloration but absolutely no charring, flaking or damage to the sheet. The roll was removed from the parchment wrapping and there was no sticking or adhesion to the sheet. The roll was closely inspected: it was extremely hot, evenly crisp on the top, sides and bottom and with no burning.

This test was then repeated a second time with the same parchment sheet and using the same method. During the second phase, the parchment discolored slightly but there was no apparent burning or flaking and it retained its strength. The roll that was heated was extremely hot. The roll did not burn and the outside crusty layer became thicker and more brittle. Based on this testing, it was determined that the TiO₂ filled parchment sheet was suitable for use in accelerated cooking ovens.

Thus, unlike other known cooking sheets, the sheet used in the present invention can withstand the high temperature conditions of an accelerated cooking oven without discoloring significantly, burning or flaking. Further, it is even suitable for reuse. This will facilitate the use of accelerated heat ovens, minimizing the need to clean out the surface of the oven between uses. It further will avoid the need for reusable containers that must be cleaned and are also expensive.

Although creping is not necessary for the functioning present invention, it does provide several different advantages. The creping provides a space or void between the food and the liner, as the food sits up on top of the peaks of the creping. This allows hot air to circulate around the food, allowing it to crisp up. The valleys in the creping further provide a space for liquid, in particular, oils to drain away from the food. This keeps the food dryer and keeps the oven clean. The creped material is also more dense. The density allows for absorption of more heat and also the more substantial sheet is easier to grab with the thumb and fingers to remove from the oven. Crepe material is also more rigid, allowing it to remain flat. It also provides more surface area per square inch, which should allow it to absorb and hold more moisture and heat per square inch than an uncreped sheet. Thus, although creping is not necessary for practicing the present invention, it does provide a superior method of cooking such food in an accelerated cooking oven.

This has been a description the present invention, along with the preferred method of practicing the present invention, however, the invention itself should only be defined by the appended claims, wherein we claim:

What is claimed is:

1. A method of cooking food comprising positioning said food on a sheet, wherein:
said sheet comprises a vegetable parchment sheet having an inert inorganic filler in an amount effective to provide heat resistance to the sheet at a temperature of 500° F. for two minutes;
heating said food on said sheet in an accelerated cooking oven, wherein said sheet is contacted with flowing hot air for a time effective to heat the food to a desired temperature.

2. The method claimed in claim 1 wherein said sheet has a first silicone release layer on a first surface of said sheet.

3. The method claimed in claim 2 wherein said sheet has a second silicone release layer on a second surface of said sheet.

4. The method claimed in claim 2 wherein said sheet is creped from about 5 to about 12%.

5. The method claimed in claim 1 wherein said inert inorganic filler is titanium dioxide.

6. The method claimed in claim 5 wherein said effective amount is from about 10 to about 40 kg per metric tonne.

7. A sheet product effective to support food products while being heated in an accelerated heat oven, said sheet comprising:
vegetable parchment filled with at least 10 kg per metric tonne of titanium dioxide; and
first and second silicone coatings on first and second surfaces of said vegetable parchment.

8. The sheet claimed in claim 7 wherein said vegetable parchment sheet is creped from about 5 to about 12%.

9. In combination, a food item resting on a liner, said liner comprises vegetable parchment filled with TiO₂ and coated on a first side with a silicone coating.
